(19) United States
(12) Patent Application Publication
(10) Pub. No.: US 2006/0178971 A1
(43) Pub. Date: Aug. 10, 2006

(54) Personal credit management and monitoring system and method

(76) Inventors: John Sheldon Owen, San Marcos, CA (US); Emily Deere, Encinitas, CA (US); James Weinberg, Carlsbad, CA (US)

Correspondence Address: FISH & RICHARDSON, PC, P.O. BOX 1022, MINNEAPOLIS, MN, 55440-1022, US

(21) Appl. No.: 11/314,200

(22) Filed: Dec. 20, 2005

Related U.S. Application Data
(60) Provisional application No. 60/637,963, filed on Dec. 20, 2004.

(51) Int. Cl. G06Q 40/00

(52) U.S. Cl. 705/35

(57) ABSTRACT

This document discloses fully-integrated consumer credit management and identity theft detection, protection and resolution systems, methods, and computer program products. These solutions enable consumers to manage the entire lifecycle of their credit profile and personal identity through a simple integrated application that combines credit management, credit monitoring, identity theft detection, and identity restoration. The credit management and identity theft protection system integrates the complexities of credit reports and identity theft protection into a single solution giving consumers more control over their financial future than conventional systems.

### CROSS REFERENCE TO RELATED APPLICATIONS

The present application claims priority under 35 U.S.C. §119 to U.S. Provisional Application Ser. No. 60/637,963, filed Dec. 20, 2004, entitled PERSONAL CREDIT MANAGEMENT AND MONITORING SYSTEM AND METHOD, the disclosure of which is incorporated herein by reference.

### BACKGROUND

One of the most important factors in the field of personal finance, if not the most important factor, is credit worthiness. Credit worthiness is in large part represented by a person's credit scores, which are quantitative values that are dependent on a variety of financial and commercial transactions related to that person. Many decisions are based on a person's credit scores: credit issuers base credit limits and interest rates to be charged, and employers even evaluate an applicant's credit scores when deciding on the trustworthiness and employability of the applicant.

Much of a person's life and well-being are dependent on favorable credit worthiness, yet many people do not comprehend the factors and considerations behind their credit scores as generated by each of several national credit scoring and reporting agencies. Further, these agencies are often rife with error: the Federal Trade Commission estimates that there are more than 2.3 billion errors reported on credit reports each year. Typically, the only way a credit scoring agency fixes an error is if a person subject to the error identifies the error and informs each credit scoring agency of the situation.

Compounding these problems is a phenomenon known as identity theft, in which a third party “steals” the identity of a third person to gain access to credit or other financial information, usually for nefarious purposes. Each year, it is estimated that there are over 10 million victims of identity theft. Credit agencies often blind to occurrences of identity theft when generating credit scores. Thus, it is up to each individual person to monitor their financial history to recognize when identity theft occurs, and yet still act to reverse or mitigate the damage done by identity theft.

### SUMMARY

This document discloses fully-integrated consumer credit management and identity theft detection, protection and resolution systems, methods, and computer program products. These solutions enable consumers to manage the entire lifecycle of their credit profile and personal identity through a simple integrated application that combines credit management, credit monitoring, identity theft detection, and identity restoration.

The credit management and identity theft protection system integrates the complexities of credit reports and identity theft protection into a single solution giving consumers more control over their financial future than conventional systems.

In one aspect, a credit management system includes a client/server application, preferably loaded onto and executed by a client computer. The desktop application includes a display section to display detailed financial and/or personal information of a user, and a “quick view” display tool to display a summarized or abbreviated version of some of the financial or personal information. The quick view display tool can include an “accounts summary” display tool to display a summary of the user's financial accounts, a “real estate” display tool to display a summary of the user's real estate-related financial information, an “installments” display tool to display a summary of the user's installment payment-related financial information, and a “revolving” display tool to display a summary of the user's revolving credit line-related financial information.

The credit management system further includes a series of dialog boxes that are selectable by a user, and that can receive information from a user to analyze various credit reports for errors or discrepancies, allow a user to make corrections or provide explanations for such discrepancies, or analyze how certain variables, when changed, can positively or negatively impact one's credit report and thus, their credit worthiness.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of a system architecture on which a credit management system can be implemented.

FIG. 2 depicts a first screen of a desktop application in accordance with some embodiments.

FIG. 3 shows a second screen of the desktop application displaying an account summary display tool.

FIG. 4 shows a third screen of the credit management system having a personal information section.

FIG. 5 shows a fourth screen of the credit management system having a collection accounts section.

FIG. 6 shows a fifth screen of the credit management system having a public records display tool and an associated public records section.

FIG. 7 shows a sixth screen of the credit management system having an inquiries display tool.

FIGS. 8A and 8B are screen shots showing detailed account information.

FIG. 9 illustrates an account dialog box of a credit management system.

FIG. 10 illustrates a credit report information comparison dialog box.

FIGS. 11A-D illustrate several correction wizard dialog boxes.

FIGS. 12A-C illustrate a credit score analyzer tool.

Like reference symbols in the various drawings indicate like elements.

### DETAILED DESCRIPTION

This document describes various embodiments of a credit management system. The credit management systems include a Credit Monitoring (CM) subsystem, which can be integrated with an Identity Theft Protection (ITP) subsystem, to provide an integrated CM/ITP system and methods for executing the same. In general, the CM/ITP provides a comprehensive early warning system that automatically monitors and reports potential fraudulent activity within a user's credit file as part of a credit management system. This integrated system proactively helps users safeguard against financial harm caused by criminals who may have stolen the user's personal information that defines their identity.

The CM/ITP system includes an automatic credit analysis program integrated into the credit management system, and which compares differences between two or more credit report files. The comparison is achieved through one or more algorithms that analyzes the user's entire credit report in near real-time, and provides alerts, reports and warnings through a flagging system. The CM/ITP system provides real-time, continuous credit monitoring, with automatically generated alerts that are sent or downloaded to a user.

The CM/ITP system alerts and warns users of any changes in their personal credit information profile based on credit information from one or more publicly accessible credit bureaus: currently TransUnion, Experian, and Equifax. Other sources of credit information for the credit information profile may also be used. The alerts are generated from algorithms that monitor, compare and analyzes changes on two or more credit reports. The alerts are driven by changes, which include but are not limited to account balance differences, installment account changes, revolving account changes, collection account changes, bankruptcy changes, personal information changes, and credit inquiry changes. The alerts and warnings are generated in a report that allows users to monitor their personal credit information at a glance.

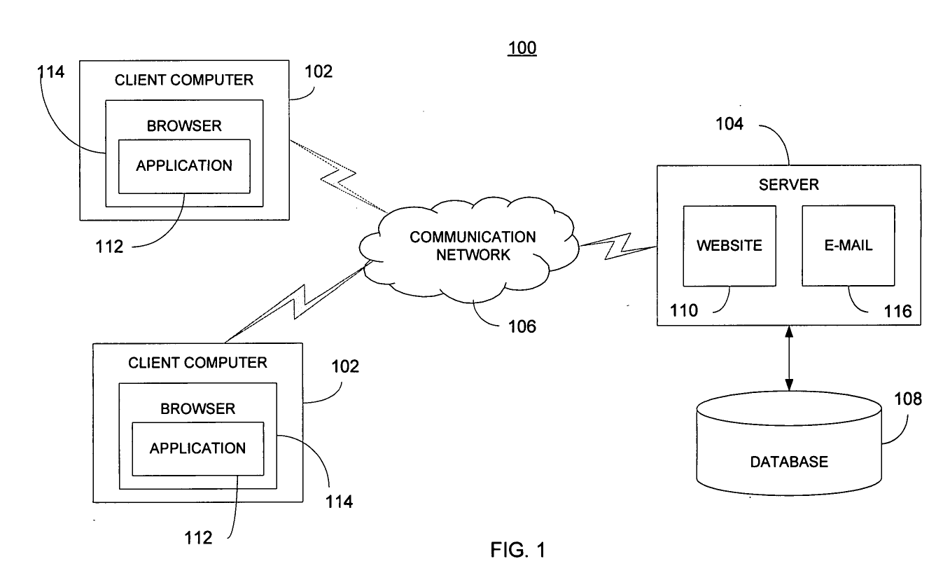

FIG. 1 is a block diagram of a system architecture 100 on which the CM and CM/ITP systems can be implemented. The architecture includes one or more client computers 102 communicating with at least one server 104 via a communication network 106. The communication network 106 is preferably the internet, and can include one or more sub-networks such as a wireless data communication network, an optical broadband network, or other types of networks using an internet communication protocol. Each client computer 102 is generally referred to herein as a “desktop,” but can also be a handheld device, a laptop computer, a personal computer or any other type of computing device. Each client computer 102 preferably includes a display, a processor for generating the display and executing application software described above, and an input device such as a keyboard, mouse, or touchscreen.

The server 104 can be a single server device attached to the communicating network 106, or part of a server farm or bank of servers. Additionally, the server 104 may part of an interconnected server network, such as in an intranet, extranet or an enterprise server system. The server 104 is connected to a database 108 for storing customer credit information, personal identity information, and other information for use by the server 104 and application software executed by each client computer 102. The database 108 can be co-located with the server 104, or connected to the server via another network, such as a network attached storage (NAS) framework. The database 108 is preferably a secure database including security frameworks for insuring for data integrity.

Credit Management System.

A credit management (CM) system includes a CM website 110 that can be accessed by and downloaded from the server 104, and a client/server desktop application 112 on a client computer 102. The desktop application 112 allows users to download and manage credit report information and other personal information from a client computer 102. The CM website 110 provides a number of credit management services and products, explained further below. The desktop application 112 can be downloaded and executed by a web browser 114 running on the client computer 102.

A user needs to register before subscribing any service or products. The user's account information, subscription information and payment information will be collected at the time of registration, and a user ID and password are established. Apart from the new user, if any exiting user has cancelled his account then he has to register again to get the new services. If any existing user reactivates a cancelled account, the user can use the same user ID and password next time after renewal of his account. After successful registration, an email is generated by an e-mail server program 116 and sent by the server 104 to an e-mail account provided by the registered user, and including the account information. After successful login to the CM website 110, the user can navigate to a download page of the CM website. The download page enables the user to download the desktop application, their latest Credit Reports (via XML file), a list of already downloaded Credit Reports and as well as proprietary document reader software, such as Adobe Acrobat Reader.

The CM website 112 will track certain information of unregistered and registered users who have visited the CM website. A web tracking tool can be run in the web server to track, and store, the user's information. The information that is tracked includes: the start and end date and time when the user visited the website; the website URL from where the user navigated; the pages of the website that the user visits, and the number of times the user visits them. Other information that can be tracked and stored includes: the session ID and User ID of the user who logins to the website; payment information of the user; and the user's demographic details like User ID, Name, Sex, Age, State, and Address etc. The web tracking tool can generate various reports based on the information collected, and the information can be stored for any length of time, i.e. with periodic or routine deletion of user information, or periodic or routine transmission to long-term storage for selected information.

Desktop Application

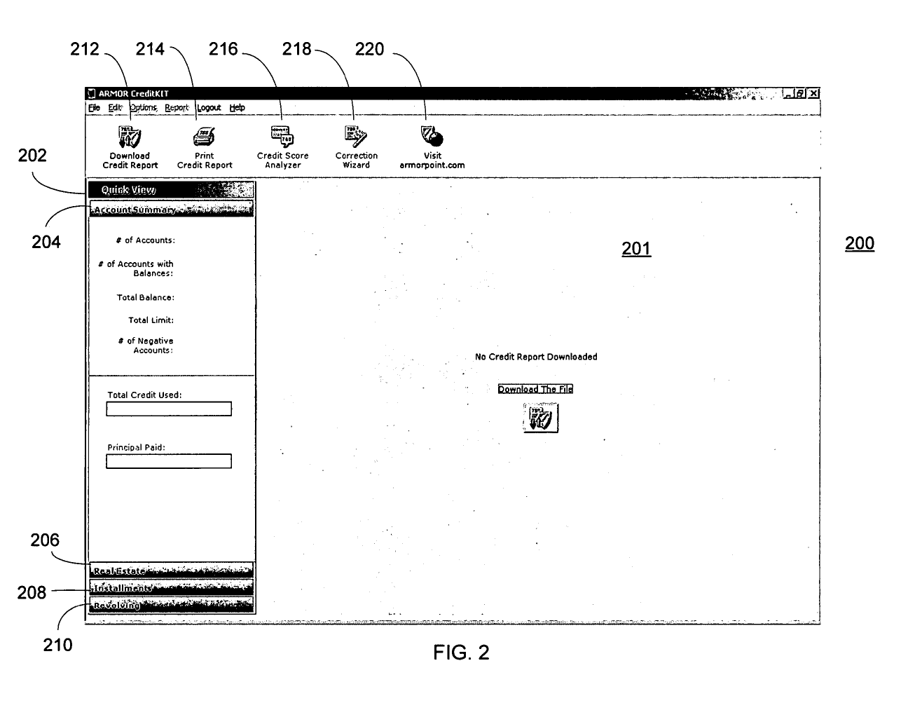

FIG. 2 depicts a first screen 200 of the desktop application 112 in accordance with some embodiments. The first screen 200 can represent the first or default web page available to a user who has successfully logged in to the CM website 110. The desktop application 112, as shown in the first screen 200, includes a display section 201 to display detailed financial and/or personal information of a user, and a “quick view” display tool 202 to display a summarized or abbreviated version of some of the financial or personal information. For instance, the quick view display tool 202 can include an “accounts summary” display tool 204 to display a summary of the user's financial accounts, a “real estate” display tool 206 to display a summary of the user's real estate-related financial information, an “installments” display tool 208 to display a summary of the user's installment payment-related financial information, and a “revolving” display tool 210 to display a summary of the user's revolving credit line-related financial information.

With these and other display tools in the quick view section 202, a user can receive a high-level accurate view of their information without having to perform any detailed analysis to generate it or complex steps to obtain it. For each of the display tools of the quick view section 202 that are selected, a more detailed view of the user's credit information is displayed in the display section 201. Several of these quick view display tools are described in further detail below.

The desktop application 112 also includes various user-selectable buttons or icons which activate and/or execute a number of tools: a “download credit report” tool 212 to allow a user to download a XML version of each of their pertinent credit reports to be viewed by the desktop software, a “print credit report” tool 214 to allow a user to print a hardcopy of their downloaded credit reports, a “credit score analyzer” tool 216 to execute a number of algorithms to analyze the user's credit scores based at least in part on the criteria used by the credit scoring agencies to generate their respective scores and reports, a “correction wizard” tool 218 that provides a series of graphical user interface (GUD) screens that display the results of executed logic to enable a user to correct errors on a downloaded credit report, and a “visit” tool 220 that allows a user to visit an informational and educational website. Most of these tools will be described in further detail below.

Account Summary Display Tool

After the user logs in, a determination is made whether an XML file exists in the desktop application path from the server 104. If such XML file exists, the user is asked by the desktop application whether to keep the XML file in the default path (option 1) or to move it to a different path (option 2). If option 2 is selected, then a new XML name and path are obtained, and the XML file is moved from the desktop application path to the new path and renamed.

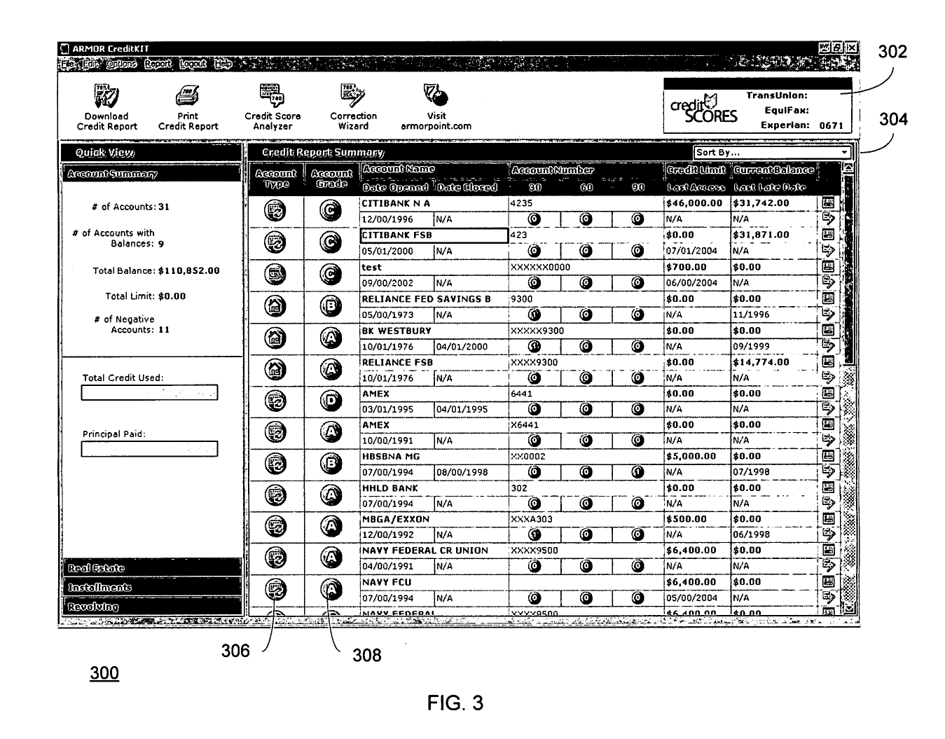

If it is option 1, then read the XML file is then read from the desktop application path, and the account summary display tool 204 is invoked. As shown in FIG. 3, which shows a second screen 300 of the desktop application, the account summary display tool 204 generates and displays a summary of the account details of each account type (i.e. Real Estate, Installment, Revolving, Collections, Public Records and Inquiries) along with the credit scores given by credit scoring and reporting agencies—EquiFax, Experian and TransUnion for example, in a credit score window 302. The credit scores window 302 is sized, colored and positioned to provide emphasis to the user's credit scores, which are the ultimate scores that can be managed with the CM system.

The account summary display tool 204 provides menu options to create the reports, logout and help feature. The second screen 300 also provides user-selectable buttons or icons for access to the download credit report tool 212, the print credit report tool 214, the credit score analyzer tool 216, the correction wizard tool 218, and the visit tool 220.

The account summary display tool 204 can be associated with a “credit report summary” section 304 that can be displayed in the display section 201. The credit report summary section 304 provides detailed account information including, without limitation, an account name, an account number, credit limit, and current balance for each credit account, as shown in FIG. 3. Each account can be displayed with an icon indicating whether the account is an individual account or a joint account.

The credit report summary section 304 can also provide account information such as date opened, date closed, a number of how many times a payment for the account was late (in various increments such as 30, 60 and 90 days), date of last access to the account, and the date on which the account payment was late. Some information, such as the number of times a payment for an account was made late, can be indicated by an icon, or otherwise highlighted or graphically disposed so as to highlight the number or emphasize the information.

The credit report summary section 304 also includes two columns of icons. A first set of icons 306, arranged in a column and each associated with a respective account, graphically represents an “account type.” For example, one icon 306 can be a credit card to represent a credit card, revolving credit, or other account, while another icon 306 can be a house to represent a home mortgage account or home equity line of credit, etc. This first set of icons 306 enables a user to understand at a glance the exact mix of account types they hold.

Credit GPA

A second set of icons 308, also arranged in a column and each associated with an account, provides a qualitative “grade” for the respective account, based on a numerical or alphanumeric grade. Preferably, the second set of icons 308 represent a scholastic-type alphanumeric grade on the scale of A, B, C, D, and F, where A is the best grade and F is the worst grade. In some embodiments, when a user scrolls a pointer over an icon 308, a dialog box appears to provide a reason for the grade or other description as to how the grade was generated.

The Credit GPA uses multiple algorithms to analyze each tradeline with a credit report provided a weighted letter grade that illustrates the affect that particular tradeline has on the overall credit scores. The Credit GPA also automatically displays an overall Credit GPA average that is related to the average credit score of a consumer.

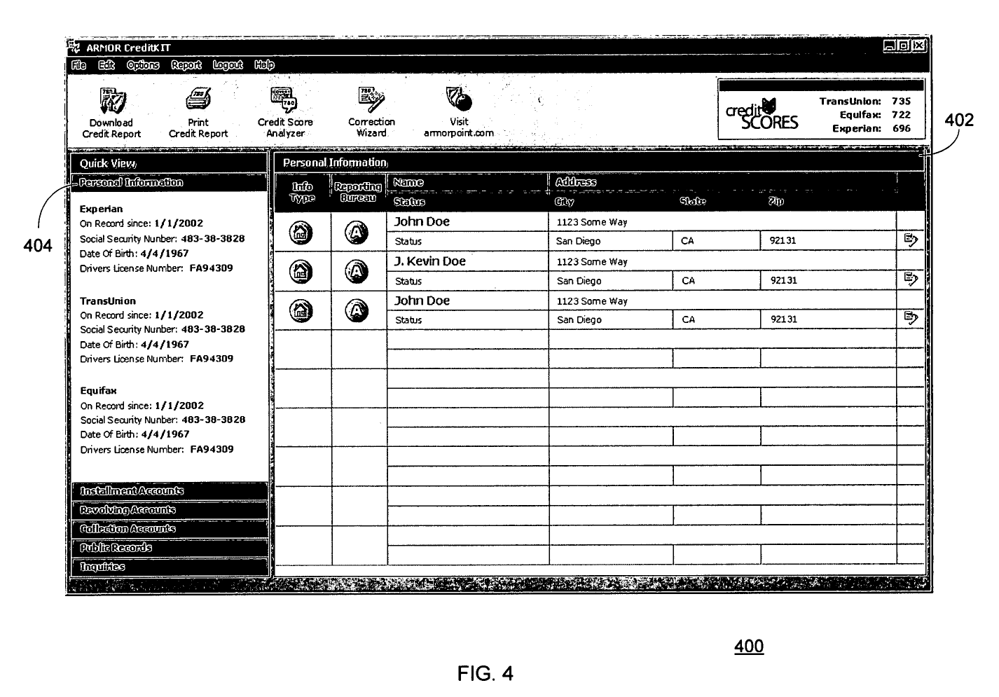

FIG. 4 shows a third screen 400 of the CM system having a “personal information” section 402 in the display section 201 and that corresponds to a “personal information” display tool 404. The personal information display tool 404 generates and displays a summary of information of the user relating to each of the several credit bureaus, so that comparisons can be made among the credit bureaus. Differences therein are highlighted, which could indicate an identity theft issue. The personal information section 402 generates and displays more detailed personal information, such as a name, address, status (marital or otherwise), city, state and zip code.

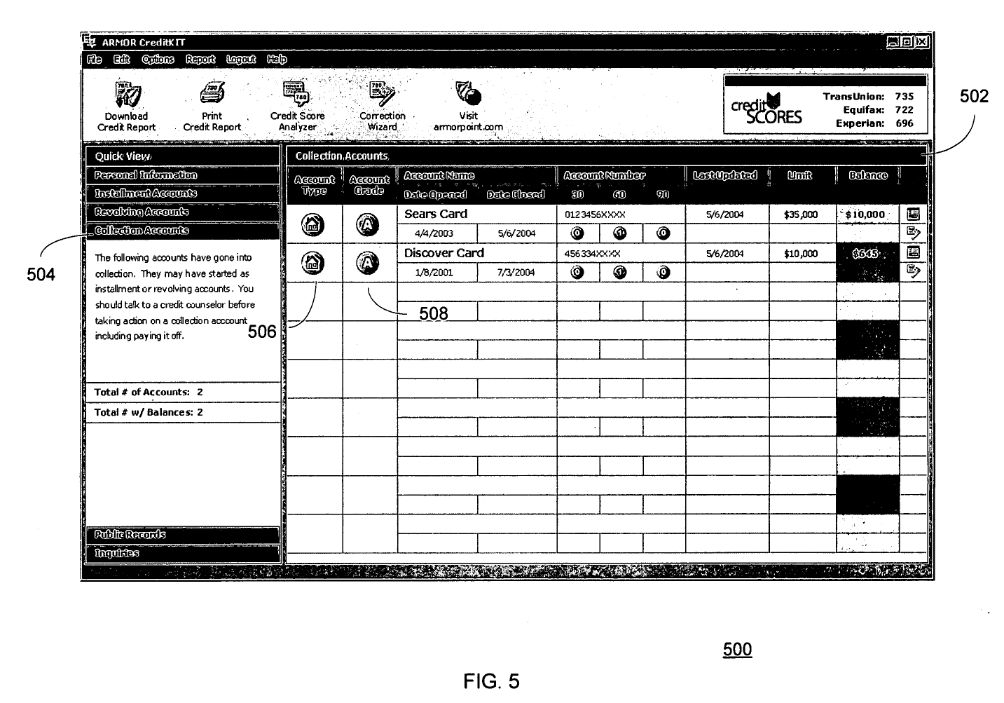

FIG. 5 shows a fourth screen 500 of the CM system having a “collection accounts” section 502 in the display section 201 and that corresponds to a “collection accounts” display tool 404. The collection accounts display tool 404 generates and displays a summary of information about any accounts relating to the user which have gone to collection, or otherwise may have been acted on in a way that has adversely effected the user's credit score. The associated collection accounts section 502 generates and displays more detailed personal information, such as account name, account number, date the account was last updated, credit limit, and balance. The collection accounts section 502 can also include a first set of icons 506 that represent an account type, as discussed above, and a second set of icons 508 that represent an account grade, also as discussed above.

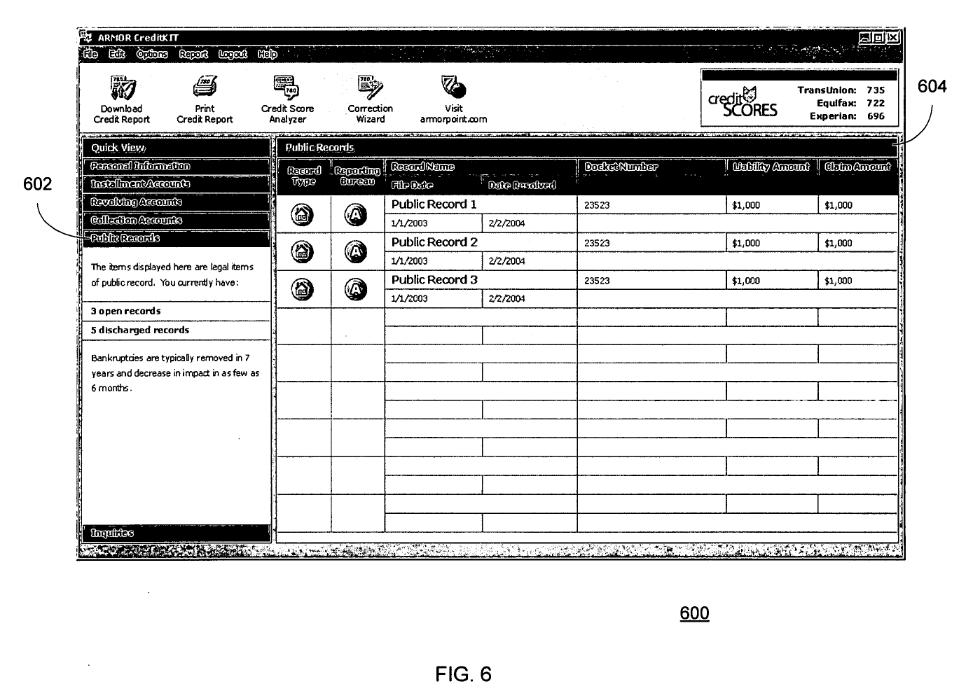

FIG. 6 shows a fifth screen 600 of the CM system having a “public records” display tool 602 and an associated “public records” section 604. The fifth screen 600 of the CM system generates and displays credit information relating to legal items of public record, such as bankruptcies, court judgments, liens, etc. The public records section 604 can include, whichever apply, such as the public record name, docket number, liability amount, claim amount, file date, and date resolved.

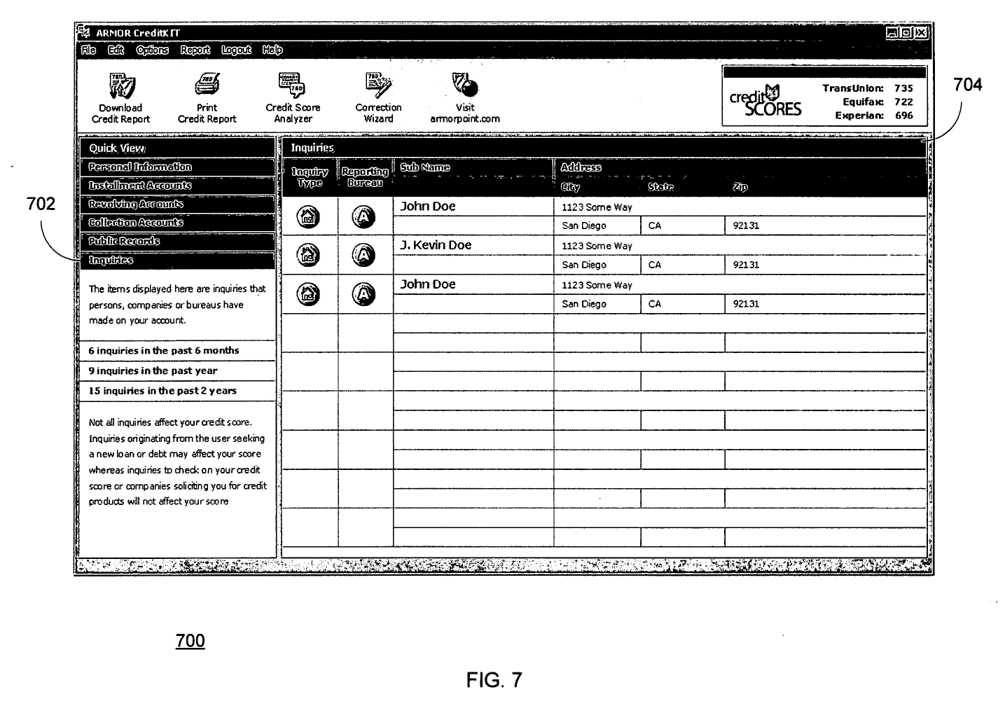

FIG. 7 shows a sixth screen 700 of the CM system having an “inquiries” display tool 702 that displays a summary of inquiries that persons, companies or bureaus have made on the user's account. Some such inquiries may affect the user's credit score, and thus the display of each of the inquiries allows a user to analyze the inquiries and address those that could adversely affect the related credit scores.

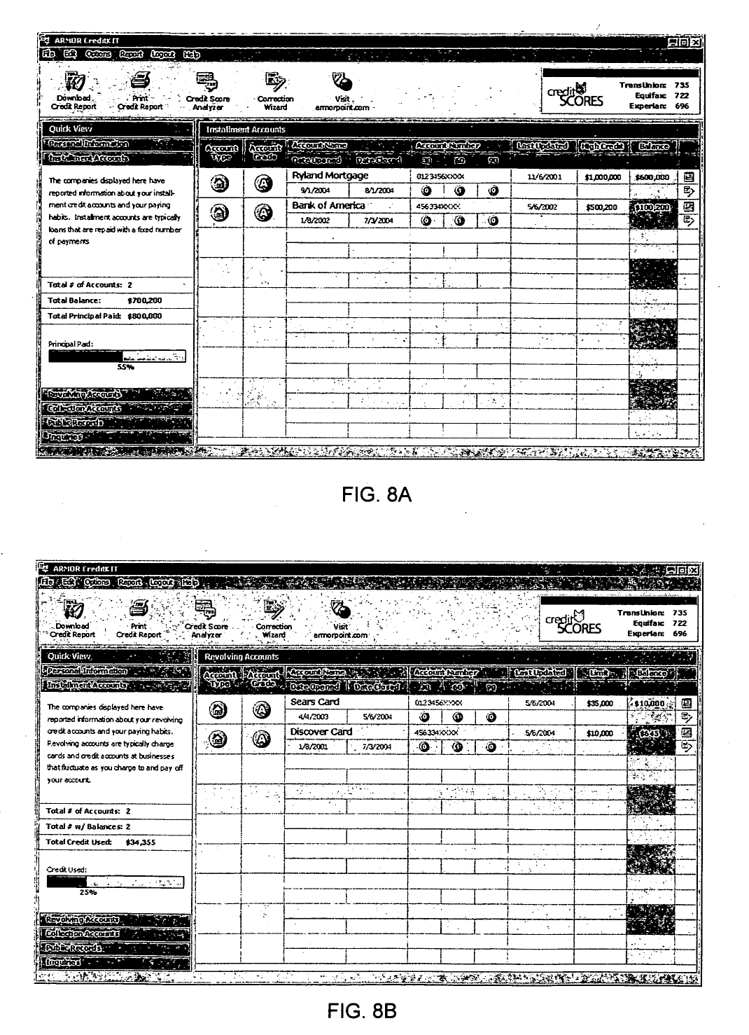

FIG. 8A shows a seventh screen 800 relating to the user's installment accounts, and FIG. 8B shows an eighth screen 802 relating to the user's revolving accounts. Each screen 800 and 802 generates and displays in the display section 201 account information such as account name, account number, date the account was last updated, the credit limit or highest amount of the credit, and the current balance. Each screen 800 and 802 in the display section 201 also include a first set of icons that represent an account type, as discussed above, and a second set of icons that represent an account grade, also as, discussed above.

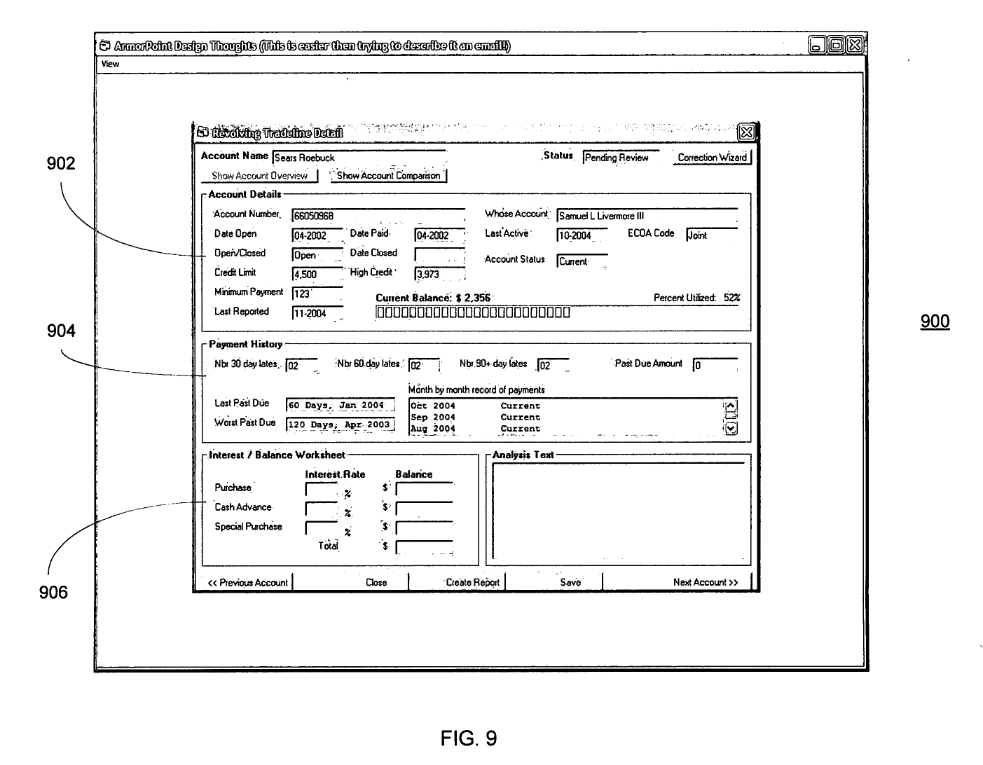

In accordance with some embodiments, the CM system can generate and display one or more dialog boxes. The dialog boxes can be employed to convey information as well as prompt a user to enter information into the dialog box for storage in the CM system. FIG. 9 illustrates an account dialog box 900, which provides detailed information about a particular account. The account dialog box 900 can be accessed simply by the user “clicking” on a particular account number or other identifing information, which identifing information can be displayed as a hyperlink. The account dialog box 900 provides account details 902, payment history 904,. The account dialog box 900 provides account information such as account name, account number, account type, account open and close dates, and minimum payment etc. The account dialog box 900 also provides a graphical representation of the account balance (i.e. in the form of an “empty” to “full” graphic) and number of late payments.

The account dialog box 900 also enables the user to enter the account's interest rate and balance, which can be stored into the local XML file, via an interest/balance worksheet 906. The interest/balance worksheet 906 is a tool that allows a user to analyze the effects of paying more or less on the account, and determining the outcome of such payment scheme. Accordingly, the account dialog box 900 provides detailed analysis of an account's present status, as well as projected effects if certain payments were made against the account, and how those effects will affect the user's credit score.

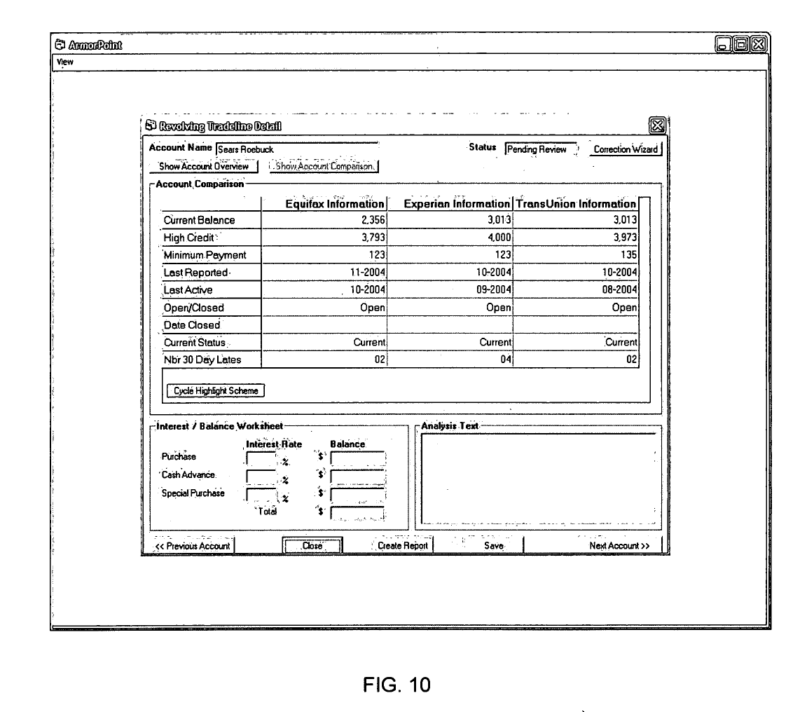

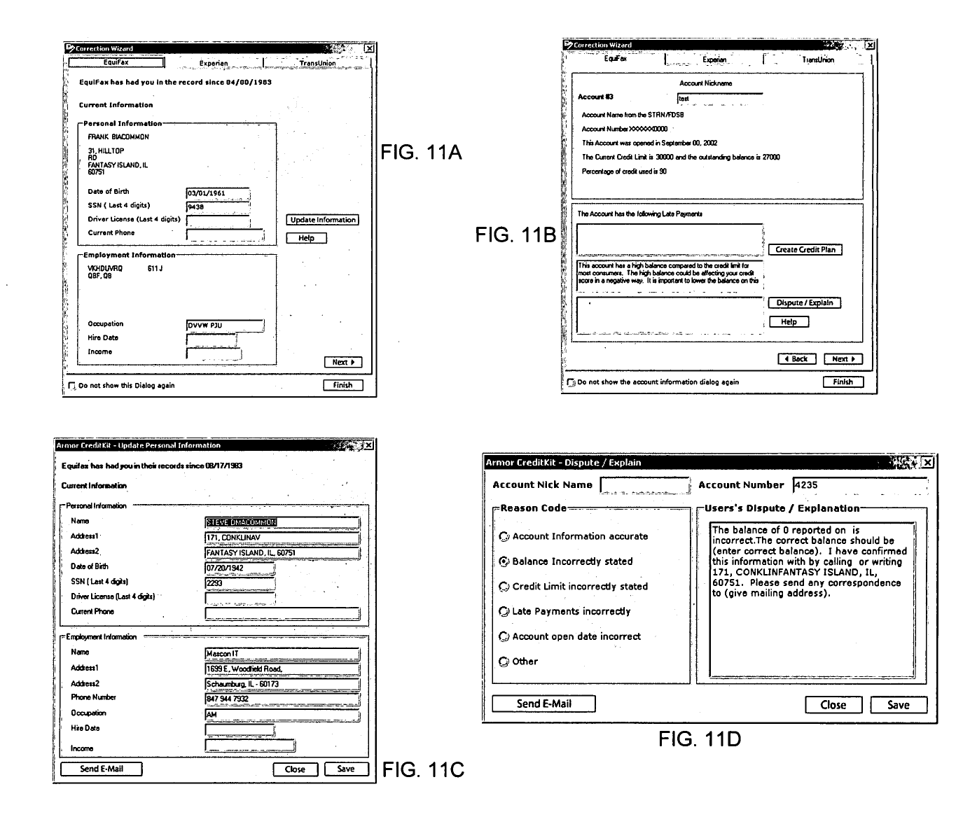

FIG. 10 illustrates another type of dialog box, a comparison dialog box 1000. The comparison dialog box 1000 generates and displays a comparison of multiple sources of account information based on a single account. For instance, as shown in FIG. 10, the comparison dialog box 1000 can show account information from three different credit bureaus, each of which should have the same or very similar information for the account. Accordingly, discrepancies among the different information sources can be highlighted, such that an error can be detected, or the error may be corrected, via, for example, the correction wizard tool 218, described in further detail below.

Correction Wizard

The correction wizard tool 218 provides access to a correction wizard dialog box 1100, shown in FIGS. 11A-D. The correction wizard dialog box 110 can be invoked in several ways: from the tool-bar icon, or from second the row-wise correction wizard icon in the display section 201.

The correction wizard tool 218 invoked from the tool-bar icon provides a series of dialog boxes that walks a user through an entire credit report. The goal is to give the user a sense of control in understanding what the credit bureaus determine about their credit report. The correction wizard tool 218 can help users figure out what each item on the report says about their credit and how to explain or dispute the item. It also shows the user's personal information given by the credit bureaus and allows the user to update their personal information, and allows the user to begin eliminating dialogs so that they can navigate quicker each time without having to make the same decisions. The user updated personal information and dispute/explanation can be mailed to the credit bureaus, either via regular mail or electronically.

FIGS. 11A-D illustrate various steps undertaken by the correction wizard tool 218. The updated personal and dispute information of different credit reports for a specific user are stored in the same XML file as was delivered for the credit reports themselves. The correction wizard tool 218 that is invoked from the row-wise icon of the account summary screen gives the details of the specific account. Personal information will not be shown in this invoked correction wizard tool 218. The credit bureaus will update the disputes that were sent by the user, so that the latest credit reports obtained for the user will contain the updated disputes.

FIG. 11A is a screen shot of a correction wizard dialog box that shows user information of each credit bureau and options for updating the user information. FIG. 11B is a screen shot of a correction wizard dialog box that shows the user's account details and options to dispute or explain errors, discrepancies, or adverse information. FIG. 11C is a screen shot of a correction wizard dialog box that shows personal information update options. FIG. 11D is a screen shot of a dispute/explanation input box as well as a user-selectable reason code that provides context to the user's dispute or explanation.

Credit Score Analyzer Tool

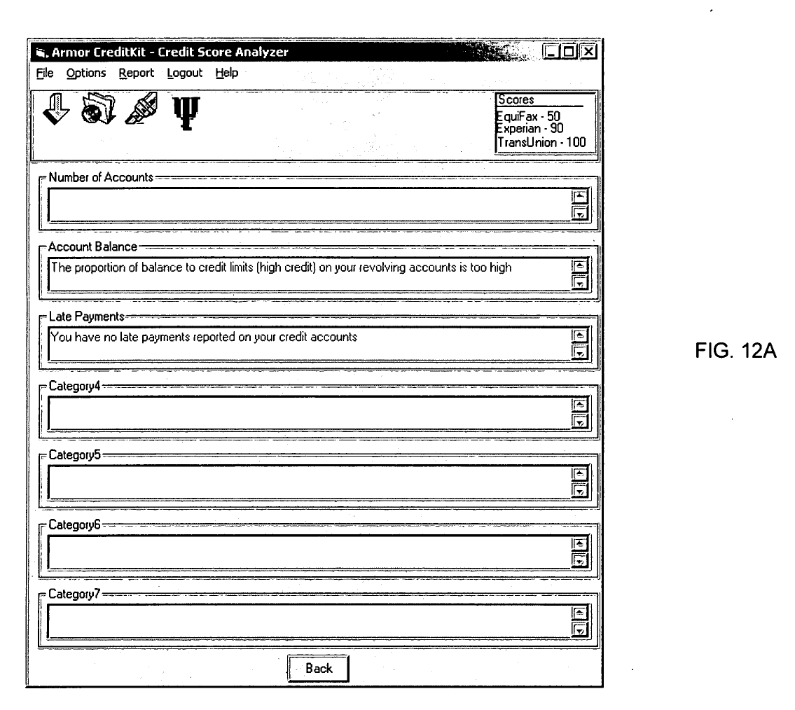

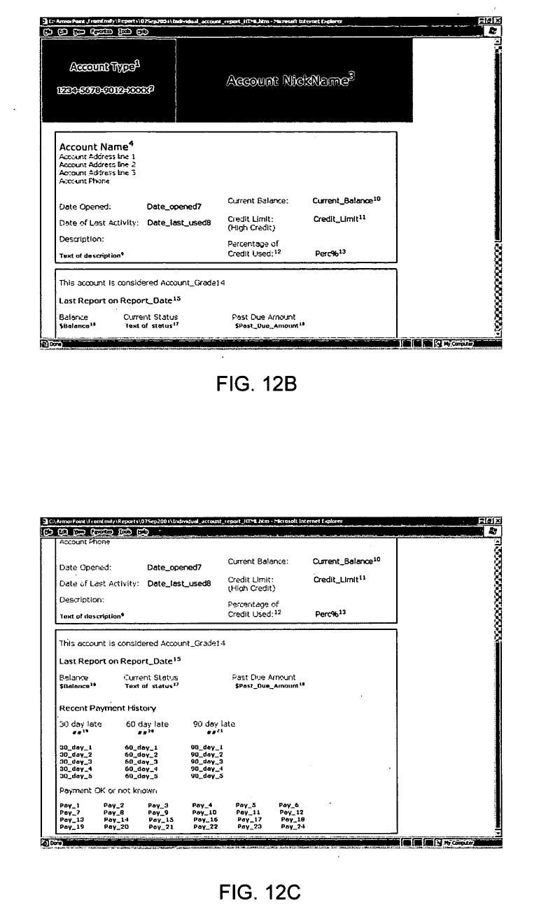

The CM system includes the credit score analyzer tool, embodied in a screen. This screen discusses about the positive and negative items category-wise that help the user affect their credit score. The listed categories include, without limitation: number of accounts, account balance, and late payments, etc, as shown in FIGS. 12A-D. A graph is generated and displayed for the following factors:

1) Total balances on credit cards

2) Overall credit score

3) Number of Accounts open with balances

4) Length of credit history

5) Credit Risk Profile

Embodiments of the invention and all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A personal credit management system comprising:
a desktop application having a display section to display financial and personal information of a user,
a quick view display tool to display a summary of the financial and personal information, the quick view display tool having a plurality of display tools for displaying one of a plurality of categories of the financial and personal information, each of the plurality of display tools being associated with an information section that is generated and displayed coincidently in the display section.

2. The system in accordance with claim 1, wherein the plurality of display tools includes an accounts summary display tool to display a summary of one or more financial accounts related to the user.

3. The system in accordance with claim 1, wherein the plurality of display tools includes a real estate display tool to display a summary of the user's real estate-related financial information,

4. The system in accordance with claim 1, wherein the plurality of display tools includes an installments display tool to display a summary of the user's installment payment-related financial information.

5. The system in accordance with claim 1, wherein the plurality of display tools includes a revolving display tool to display a summary of the user's revolving credit line-related financial information.

6. A method for managing credit information, comprising:
receiving two or more credit reports via an electronic communications network;
displaying information from the two or more credit reports in a table such that similar information from each of the credit reports is displayed side-by-side; and
identifying a discrepancy among the similar information from the two or more credit reports.

7. A method in accordance with claim 6, further comprising:
automatically generating a message for at least one source of the two or more credit reports; and
receiving user input in the message for delivery to the at least one source.

8. A method in accordance with claim 7, wherein the user input includes an explanation for the discrepancy.

9. A method in accordance with claim 8, wherein the user input includes a question for the at least one source relating to the discrepancy.

10. A method in accordance with claim 7, further comprising transmitting the message to the at least one source.

11. A method in accordance with claim 10, further comprising storing the transmitted message in a database.

12. A method in accordance with claim 6, wherein the credit report is associated with one or more credit accounts related to a user, and wherein the method further comprises determining a grade for each one of the one or more credit accounts.

13. A method in accordance with claim 12, wherein the one or more credit accounts includes a tradeline or individual account.

14. A method in accordance with claim 12, further comprising generating a graphical symbol representing the grade for each one of the one or more credit accounts.

15. A method in accordance with claim 14, further comprising displaying the graphical symbol representing the grade in a section of a website.

16. A method in accordance with claim 14, wherein the graphical symbol includes an alphanumeric character.

17. A method in accordance with claim 16, wherein the alphanumeric character is a letter selected from the group of letters that consists of: A, B, C, D, and F.

18. A method in accordance with claim 14, wherein the graphical symbol includes a hyperlink to detailed information about the grade.

19. A method in accordance with claim 18, wherein the detailed information includes credit scoring information.

20. A method in accordance with claim 19, further comprising:
displaying a representation of an impact the detailed information has on the user's credit score.
